(19) United States
(12) Patent Application Publication
(10) Pub. No.: US 2016/0203798 A1
(43) Pub. Date: Jul. 14, 2016

(54) LIQUID CRYSTAL DISPLAY DEVICE HAVING AT LEAST THREE ELECTRODES IN EACH PIXEL AREA

(71) Applicant: VastView Technology Inc., Hsinchu County (TW)

(72) Inventors: Cheng Chung Peng, Hsinchu County (TW); Yuhren Shen, Hsinchu County (TW)

(21) Appl. No.: 14/595,346

(22) Filed: Jan. 13, 2015

(51) Int. Cl. G09G 5/18; G09G 3/36

(52) U.S. Cl. CPC G09G 5/18; G09G 3/3696; G09G 2300/0426

(57) ABSTRACT

A liquid crystal display (LCD) device includes at least three electrodes disposed between a liquid crystal layer and two substrates in each pixel area with at least one electrode between the liquid crystal layer and each of the two substrates. Each pixel area has at least two sub-pixel areas applied with different electrode voltages. One of the electrodes is applied with a DC voltage. Two of the electrodes are applied respectively with first and second AC voltages synchronous with an LCD timing signal. Both first and second AC voltages have a high-level period and a low-level period equal to the high-level period. The timing period of the LCD timing signal is at least one or more times of the high-level periods of the two AC voltages with the high-level period of the first AC voltage longer than the high-level period of the second AC voltage.

### BACKGROUND OF THE INVENTION

1. Field of the Invention

The present invention relates to a liquid crystal display (LCD) device, and more particularly to an LCD device having sub-pixel areas in each pixel for improving viewing angle and reducing flicker.

2. Description of Related Arts

An LCD device controls the light transmittance by using the characteristic that liquid crystal (LC) molecules present different light polarization or refraction effects under different alignments so as to produce images. A twisted nematic (TN) LCD device has good light transmittance but an extremely narrow viewing angle as influenced by the structure and optical characteristic of the LC molecules.

To solve the transmittance and viewing angle problems, a twisted vertical alignment model has been proposed so as to provide the high transmittance and the wide viewing angle. However, because the LC molecules are aligned in a vertical alignment manner, when the LC molecules are applied with a low voltage and the LCD device is watched at an inclined viewing angle, a gray-level inversion problem occurs, which causes the problem of color shift at an inclined viewing angle and influences a normal presentation of images of the LCD device.

To resolve this issue, two or more alignment domains are formed in the same pixel to form multi-domain vertical alignment (MVA) LCD device so as to eliminate the gray-level inversion problem and increase the viewing angles. In practice, three specific methods are provided. In the first method, one pixel is divided into multiple sub-pixel areas, and every sub-pixel area forms a different voltage by means of capacitive coupling, thereby producing the alignment effect of multiple sub-pixel areas. In the second method, one pixel is divided into multiple sub-pixel areas and two thin film transistors are used to make each sub-pixel area form a different voltage, thereby solving the gray-level inversion problem. In the third method, the pixel is divided into two or more sub-pixel areas and an electronic barrier material is covered above a part of the electrode of the sub-pixel area, thereby producing the alignment effect of multiple sub-pixel areas.

However, the methods for solving the above mentioned problem in the prior arts have complicated LCD device processes. In view of the above, it is the subject of the present invention to provide a simple method and electrode structure for driving the LCD device with high transmittance, wide viewing angle and low flicker so that the LCD device can present optimal images.

### SUMMARY OF THE INVENTION

The present invention has been made to provide an LCD device with wide viewing angle and low flicker without requiring complicated processes in manufacturing the LCD device. Accordingly, the LCD device comprises a first substrate, a first alignment layer, a liquid crystal layer, a second alignment layer, a passivation layer and a second substrate stacked from top to bottom with a plurality of pixel areas formed on the LCD device.

The LCD device includes at least three electrodes disposed between the liquid crystal layer and the two substrates in each pixel area with at least one electrode between the liquid crystal layer and each of the two substrates. According to the present invention, each pixel area has at least two sub-pixel areas applied with different electrode voltages.

One of the electrodes is a non-patterned planar electrode applied with a DC voltage. Two of the electrodes are applied respectively with first and second AC voltages synchronous with an LCD timing signal. Both first and second AC voltages have a high-level period and a low-level period equal to the high-level period. The timing period of the LCD timing signal is at least one or more times of the high-level periods of the two AC voltages with the high-level period of the first AC voltage longer than the high-level period of the second AC voltage.

In a first embodiment of the present invention, each pixel area includes a first electrode formed on the first substrate and a second electrode formed on the second substrate. Both first and second electrodes are non-patterned planar electrodes covering the pixel area. The pixel area is divided into two sub-pixel areas that may be two separate sub-pixel areas or one disposed in the center portion of the other. A third electrode and a fourth electrode are formed on the passivation layer and the second alignment layer is then formed above the passivation layer and the electrodes to embed the two electrodes respectively in the two sub-pixel areas.

According to one variation of the first embodiment, the non-patterned planar second electrode formed on the second substrate is replaced by a patterned second electrode. In a further variation, the patterned second electrode is formed on the passivation layer and embedded in the second alignment layer, and the third and fourth patterned electrodes are formed on the second substrate.

In another variation of the first embodiment, the second electrode formed on the second substrate in the first sub-pixel area is a non-patterned planar electrode but in the second sub-pixel area is a patterned electrode. The first sub-pixel area also includes a patterned third electrode embedded in the second alignment layer while the second sub-pixel area has no electrode embedded in the second alignment layer.

In yet another variation of the first embodiment, the second electrode formed on the second substrate is a patterned electrode. The first sub-pixel area has a third electrode and a fourth electrode embedded in the second alignment layer and the second sub-pixel area has the third electrode and a fifth electrode embedded in the second alignment layer. The third, fourth and fifth electrodes are all patterned electrodes.

In accordance with a further variation of the first embodiment, the two sub-pixel areas have their respective non-patterned planar electrodes formed on the second substrate. Each sub-pixel area has a third electrode and a fourth electrode embedded in the second alignment layer above the passivation layer. Both third and fourth electrodes are patterned electrodes.

According to a second embodiment of the present invention, the first substrate is formed with two separate non-patterned planar electrodes respectively in the two sub-pixel areas, and a second electrode is formed on the second substrate. The second electrode is a non-patterned planar electrode covering the pixel area. A third electrode and a fourth electrode are formed on the passivation layer and embedded in the second alignment layer respectively in the two sub-pixel areas.

In a variation of the second embodiment, a third electrode and a fourth electrode are formed on the passivation layer and embedded in the second alignment layer in each sub-pixel area. In other words, each sub-pixel area has two different patterned electrodes instead of only one patterned electrode.

In another variation of the second embodiment, each sub-pixel area also has two different patterned electrodes, and the second electrode formed on the second substrate is a patterned electrode covering the pixel area instead of a non-patterned planar electrode.

In a further variation of the second embodiment, the first substrate is formed with two separate non-patterned planar electrodes respectively in the two sub-pixel areas. The second electrode formed on the second substrate is a patterned electrode covering the pixel area and there is no electrode embedded in the second alignment layer.

### BRIEF DESCRIPTION OF THE DRAWINGS

The present invention will be apparent to those skilled in the art by reading the following detailed description of preferred embodiments thereof, with reference to the attached drawings, in which:

FIG. 1 shows a cross sectional view of an LCD device having at least three electrodes according to the first embodiment of the present invention;

FIG. 2 shows a top view of a pixel area defined by the data line and the gate line in the LCD device of FIG. 1 for illustrating the third and fourth electrodes embedded in the second alignment layer;

FIG. 3 shows a cross sectional view of the LCD device of FIG. 1 along the dotted line marked by A-A′ in FIG. 2;

FIG. 4 shows exemplary wave forms of the LCD timing signal, the DC voltage applied to the first electrode, the AC voltages applied to the second, third and fourth electrodes of the LCD device in the first embodiment;

FIG. 5 shows more exemplary wave forms of the LCD timing signal, the DC voltage applied to the first electrode, the AC voltages applied to the second, third and fourth electrodes of the LCD device in the first embodiment;

FIG. 6 shows the pixel area having a second sub-pixel area disposed in the center portion of a first sub-pixel area;

FIGS. 7(A)-(C) show three examples of the patterned electrodes having a plurality of closed or un-closed elongated apertures;

FIG. 8 shows a cross sectional view of an LCD device having at least three electrodes according to a variation of the first embodiment of the present invention;

FIG. 9 shows a cross sectional view of the LCD device of FIG. 8 similar to the one shown in FIG. 3;

FIG. 10 shows a cross sectional view of an LCD device having at least three electrodes according to a further variation of the first embodiment of the present invention;

FIG. 11 shows a cross sectional view of an LCD device having at least three electrodes according to yet another variation of the first embodiment of the present invention;

FIG. 12 shows a top view of a pixel area defined by the data line and the gate line in the LCD device of FIG. 11 for illustrating the second and third electrodes;

FIG. 13 shows a cross sectional view of an LCD device having at least three electrodes according to yet a further variation of the first embodiment of the present invention;

FIG. 14 shows a top view of a pixel area defined by the data line and the gate line in the LCD device of FIG. 13 for illustrating the third, fourth and fifth electrodes embedded in the second alignment layer;

FIG. 15 shows a cross sectional view of an LCD device having at least three electrodes according to another variation of the first embodiment of the present invention;

FIG. 16 shows a top view of a pixel area defined by the data line and the gate line in the LCD device of FIG. 15 for illustrating the third and fourth electrodes embedded in the second alignment layer;

FIG. 17 shows a cross sectional view of an LCD device having at least three electrodes according to the second embodiment of the present invention;

FIG. 18 shows a cross sectional view of an LCD device having at least three electrodes according to a variation of the second embodiment of the present invention;

FIG. 19 shows a cross sectional view of an LCD device having at least three electrodes according to another variation of the second embodiment of the present invention; and

FIG. 20 shows a cross sectional view of an LCD device having at least three electrodes according to a further variation of the second embodiment of the present invention.

### DETAILED DESCRIPTION OF THE PREFERRED EMBODIMENT

The accompanying drawings are included to provide a further understanding of the invention, and are incorporated in and constitute a part of this specification. The drawing illustrates embodiments of the invention and, together with the description, serves to explain the principles of the invention.

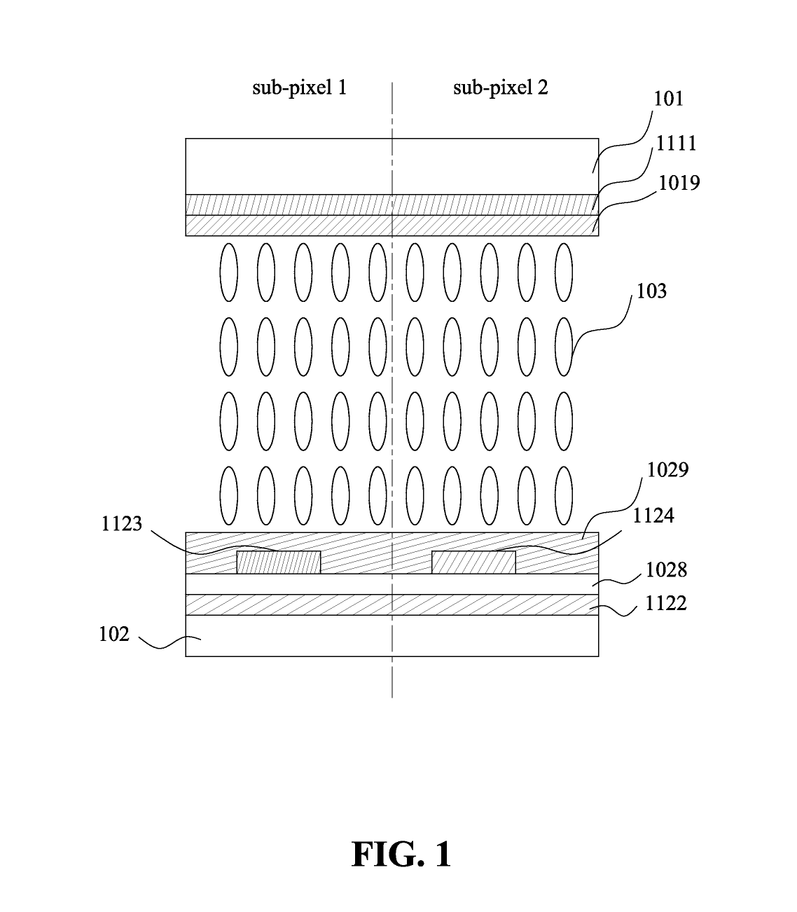

FIG. 1 shows a cross sectional view of an LCD device having at least three electrodes according to the first embodiment of the present invention. With reference to FIG. 1, the LCD device of the present invention comprises a first substrate 101, a second substrate 102 and a liquid crystal layer 103 disposed between the first and second substrates.

A plurality of pixel areas is formed on the LCD device. Each pixel area includes a first electrode 1111 formed on the first substrate 101 and a second electrode 1122 formed on the second substrate 102. The first electrode 1111 is the common electrode of the pixel area. Both first electrode 1111 and second electrode 1122 are non-patterned planar electrodes covering the pixel area. The pixel area is divided into at least two sub-pixel areas.

A passivation layer 1028 is formed above the second electrode 1122, and a third electrode 1123 and a fourth electrode 1124 are respectively formed in the two sub-pixel areas on the passivation layer 1028 as shown in FIG. 1. Both the third electrode 1123 and the fourth electrode 1124 are patterned electrodes. The passivation layer 1028 may be a single layer or a multi-layer structure formed by an organic or inorganic insulating material. The first, second, third and fourth electrodes are formed by transparent conductive films such as indium tin oxide (ITO) or indium zinc oxide (IZO).

A first alignment layer 1019 is disposed between the first electrode 1111 and the liquid crystal layer 103, and a second alignment layer 1029 is disposed between the passivation layer 1028 and the liquid crystal layer 103 with the third electrode 1123 and the fourth electrode 1124 embedded in the second alignment layer 1029. At least one of the two alignment layers comprises an alignment film for vertical alignment or horizontal alignment.

The liquid crystal layer 103 in the LCD device of the present invention comprises nematic liquid crystal molecules of negative dielectric anisotropy or a liquid crystal mixture of negative dielectric anisotropic nematic liquid crystal molecules and Chiral dopant. It can also an liquid crystal layer comprising nematic liquid crystal molecules of positive dielectric anisotropy or a liquid crystal mixture of positive dielectric anisotropic nematic liquid crystal molecules and Chiral dopant.

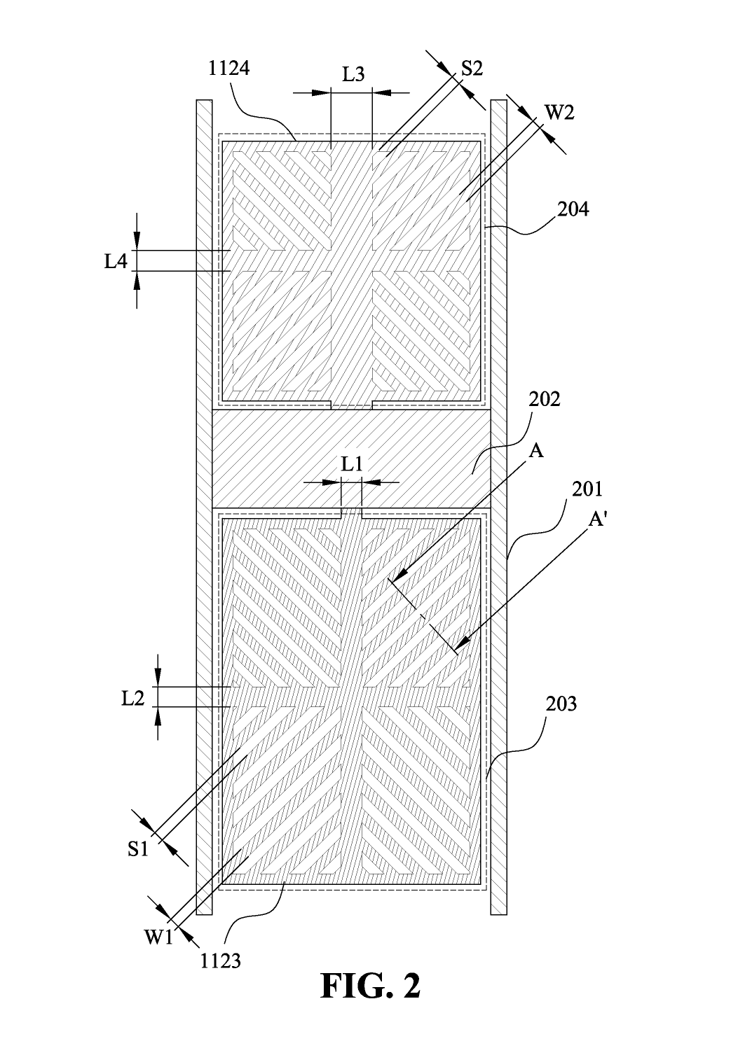

FIG. 2 shows a top view of a pixel area defined by the data line 201 and the gate line in the LCD device of FIG. 1 for illustrating the third and fourth electrodes 1123, 1124. As shown in FIG. 2, the pixel area comprises a first sub-pixel area 203 and a second sub-pixel area 204 and a non-transparent area 202. The non-transparent area 202 includes the area formed by non-transparent materials outside of the transparent pixel area. There are metal lines (not illustrated), data lines, gate lines (not illustrated), thin film transistor (TFT) devices (not illustrated) and a black matrix area deposited in the non-transparent area 202.

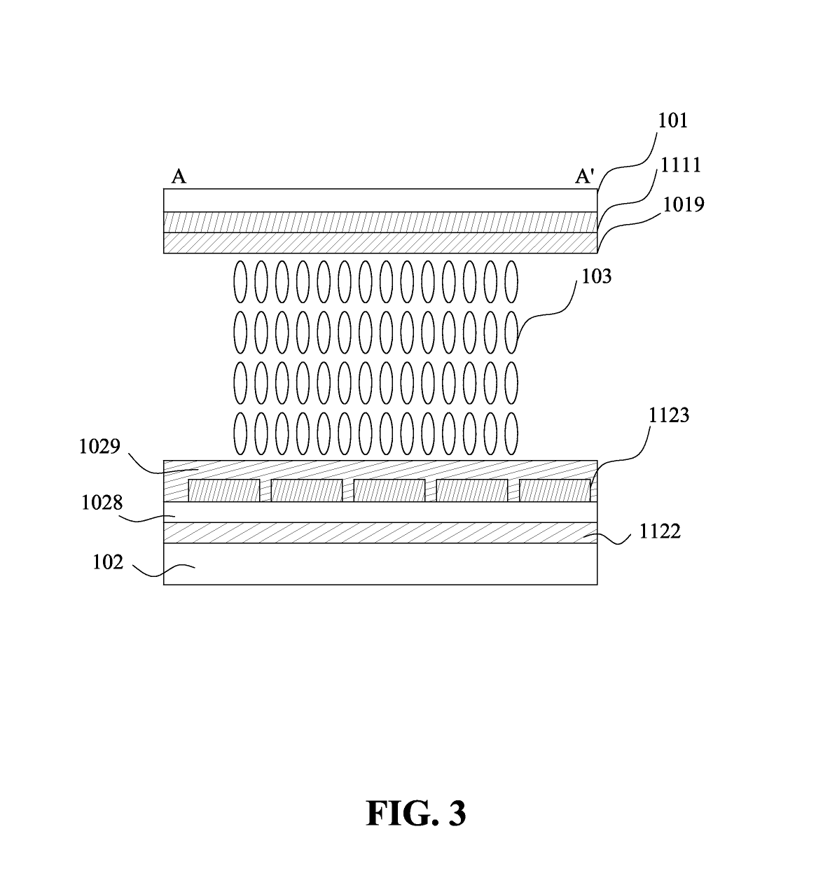

The patterned electrodes shown in the sub-pixel areas of FIG. 2 are formed with transparent conductive materials such as indium tin oxide (ITO) or indium zinc oxide (IZO). The driving circuit of each pixel area may comprise one, two or three TFTs. The structure of the driving circuit may be two transistor (TT) type, capacitively coupled (CC) type or charge shared type. FIG. 3 shows a cross sectional view of the LCD device along the dotted line marked by A-A′ in FIG. 2.

With reference to FIG. 2, L1 and L2 represent the widths of the vertical and horizontal main trunks in the middle of the patterned electrode in the first sub-pixel area 203, W1 represents the width of the branches extending out from the main trunks in the first sub-pixel area 203, and S1 represents the width of the slits between the branches in the first sub-pixel area 203. According to the present invention, L1 may be equal to or different from L2, and S1 may also be equal to or different from W1.

Similarly, L3 and L4 represent the widths of the vertical and horizontal main trunks in the middle of the patterned electrode in the second sub-pixel area 204, W2 represents the width of the branches extending out from the main trunks in the second sub-pixel area 204, and S2 represents the width of the slits between the branches in the second sub-pixel area 204. L3 may be equal to or different from L4, and S2 may also be equal to or different from W2. Furthermore, L3 may be equal to or different from L1, L4 may be equal to or different from L2, S2 may be equal to or different from S1, and W2 may be equal to or different from W1.

In accordance with the present invention, either the vertical synchronization signal Vsync or the horizontal synchronization signal may be the timing signal of the LCD device. The preferred LCD timing signal is Vsync. The first electrode 1111 is applied with a DC voltage Vcom. The second electrode 1122 is applied with an AC voltage VP which is synchronous with Vsync of the LCD device. The third electrode 1123 is applied with an AC voltage Vb1 and the fourth electrode 1124 is applied with an AC voltage Vb2. Both Vb1 and Vb2 are synchronous with Vsync.

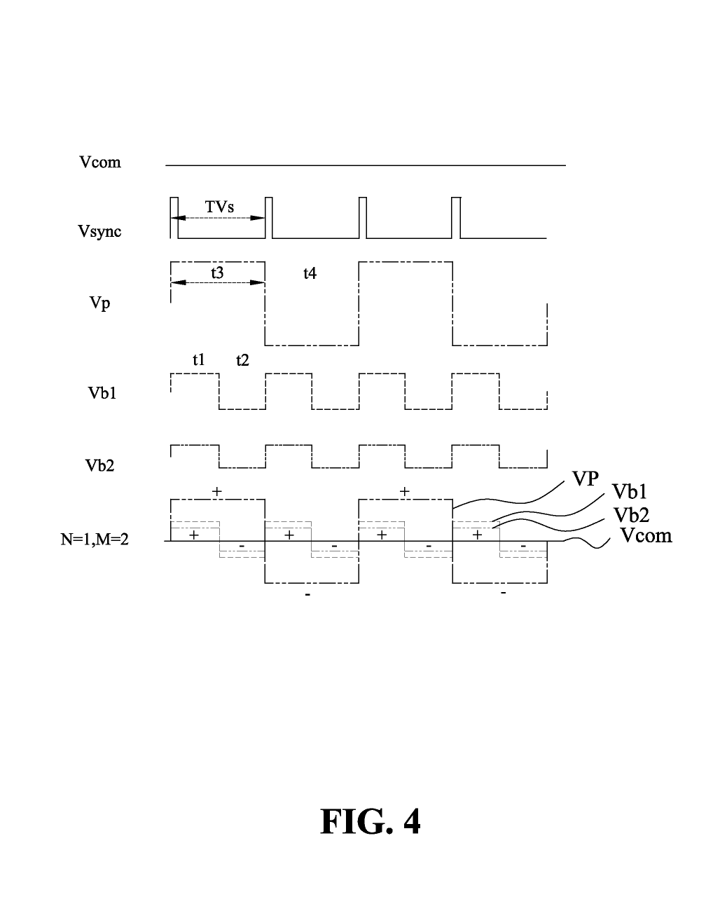

As shown in FIG. 4, the high-level period t3 of VP is equal to the low-level period t4 that is also equal to the full period TVs of Vsync. Vb1 has a high-level period t1 equal to a low-level period t2. Similarly, Vb2 also has a high-level period t1 equal to a low-level period t2. According to the preferred embodiments of the present invention, TVs/t3=N and TVs/t1=M, with N being an integer number greater than or equal to 1, M being an integer number greater than or equal to 2 and M being greater than N. Preferably, the ratio of M to N is an integer greater than or equal to 2. In other words, the high-level period of VP is longer than the high-level period of Vb1 or Vb2. It should be noted that the DC voltage Vcom is used as reference for specifying the high-level or low-level period of VP, Vb1 or Vb2. In the high-level period, the AC voltage is greater than Vcom and in the low-level period, the AC voltage is less than Vcom.

As an example, Vsync is a 60 Hz scanning signal, i.e., TVs=1/60 seconds. The AC voltage VP may have a high-level period t3=1/60 seconds if N is equal to 1, and the AC voltage Vb1 or Vb2 may have a high-level period t1=1/120 seconds if M is equal to 2. The waveforms shown in the bottom part of FIG. 4 illustrate the relationships among AC voltages VP, Vb1 and Vb2 for the example of N=1 and M=2. It should be noted that in this example, during either the high-level or low-level period of VP, both AC voltages Vb1 and Vb2 change from the high-level period to the low-level period, and the magnitude of Vb1 is greater than that of Vb2.

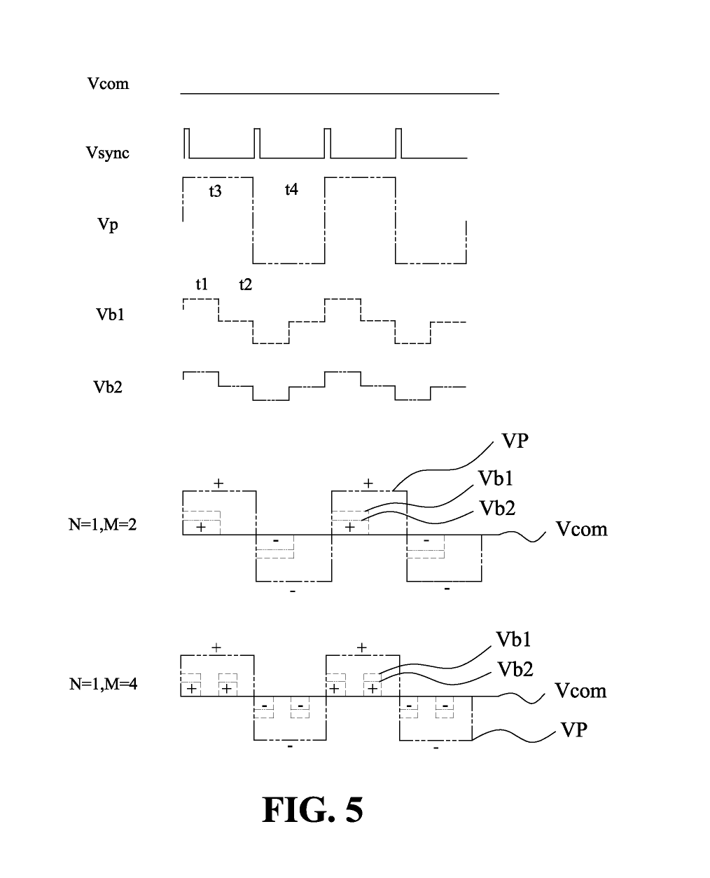

According to the present invention, AC voltages Vb1 and Vb2 may decrease from their high-levels to Vcom during the high-level period of VP, decrease further to their low-levels only during the low-level period of VP and then increase to Vcom as shown in FIG. 5 in the low-level period of VP. The waveforms shown in the bottom parts of FIG. 5 illustrate the relationships among AC voltages VP, Vb1 and Vb2 for the two cases N=1 and M=2, and N=1 and M=4.

As shown in FIG. 5, each cycle of the AC voltage VP consists of the high-level period t3 and the low-level period t4. In the case of N=1 and M=2, each cycle of Vb1 or Vb2 consists of the high-level period t1 followed by a middle level period t2 followed by the low-level period and then followed by another middle level period. The high-level period, middle-level period and low-level period all have identical duration. During the middle level period, Vb1 or Vb2 may be equal or unequal to Vcom.

In the case of N=1 and M=4, each cycle of Vb1 or Vb2 is formed by one high-level period followed by one middle-level period followed by one high-level period followed by one middle-level period followed one low-level period followed by one middle-level period followed one low-level period followed by one middle-level period. It should be noted that in this case, during the high-level period of VP, both AC voltages Vb1 and Vb2 have two high-level periods, and during the low-level period of VP, both AC voltages Vb1 and Vb2 have two low-level periods.

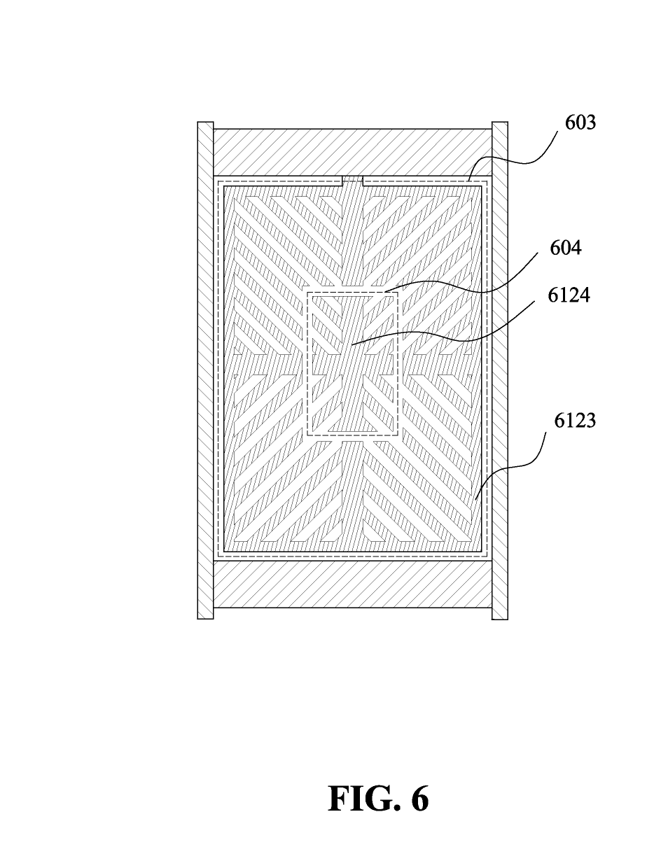

The pixel area comprising two separated sub-pixel areas 203 and 204 shown in FIG. 2 are two separate non-overlapping sub-pixel areas. According to the present invention, the two sub-pixel areas may also be distributed in a different way in the pixel area. For example, FIG. 6 shows a second sub-pixel area 604 in the center portion of a first sub-pixel area 603. The third and fourth electrodes 6123, 6124 are patterned electrodes respectively formed in the two sub-pixel areas 603, 604.

The patterned electrodes shown in FIG. 2 comprise a plurality of closed elongated apertures in the sub-pixel areas. In FIG. 6, the third electrode 6123 in the first sub-pixel area 603 also includes a plurality of closed elongated apertures. However, some of the elongated apertures have one end opened because of the second sub-pixel area 604 formed in the center portion. The fourth electrode 6124 includes a plurality of un-closed elongated apertures.

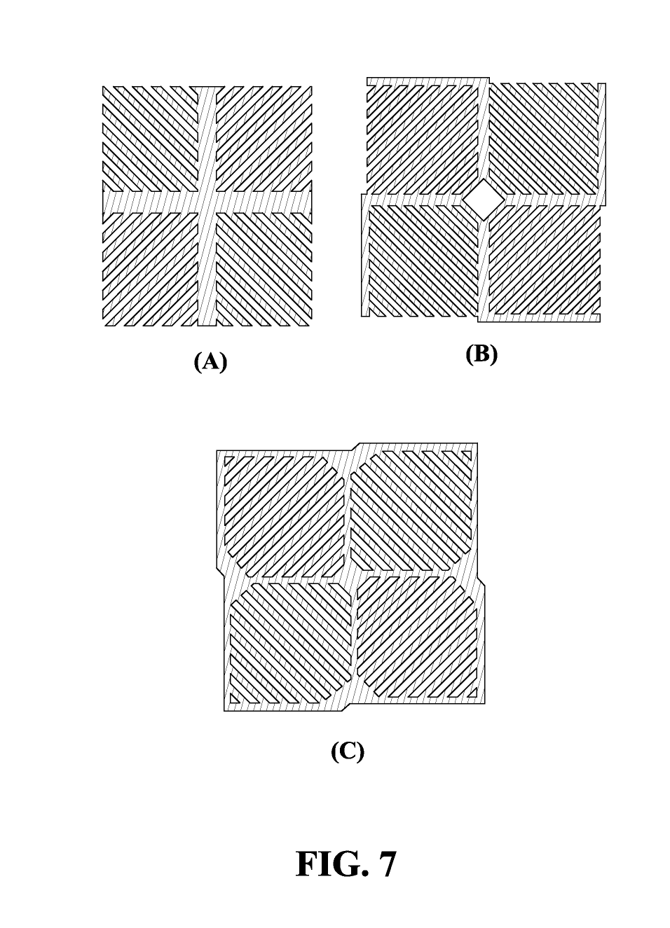

In order to improve the viewing angle and reduce the gray-level inversion problem of the LCD device, the electrode patterns formed in the third and fourth electrodes may also have different forms. For example, FIGS. 7(A)-(C) are a few electrode patterns that can be formed in the first or second sub-pixel areas.

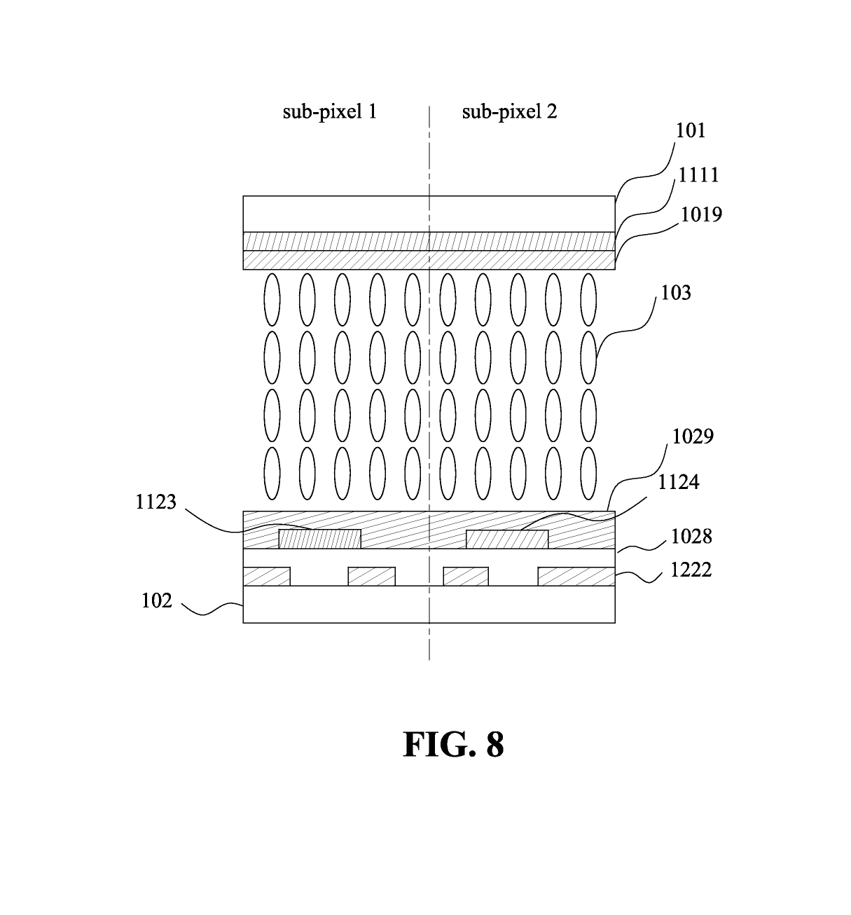

FIG. 8 shows a cross sectional view of an LCD device having at least three electrodes according to a variation of the first embodiment of the present invention. In comparison to the first embodiment shown in FIG. 1, it can be seen that the structure of the LCD device in FIG. 8 is almost identical to that of FIG. 1 except that the non-patterned planar second electrode 1122 formed on the second substrate 102 is replaced by a patterned electrode 1222. In other words, the second, third and fourth electrodes are all patterned electrodes in this variation of the first embodiment of the present invention.

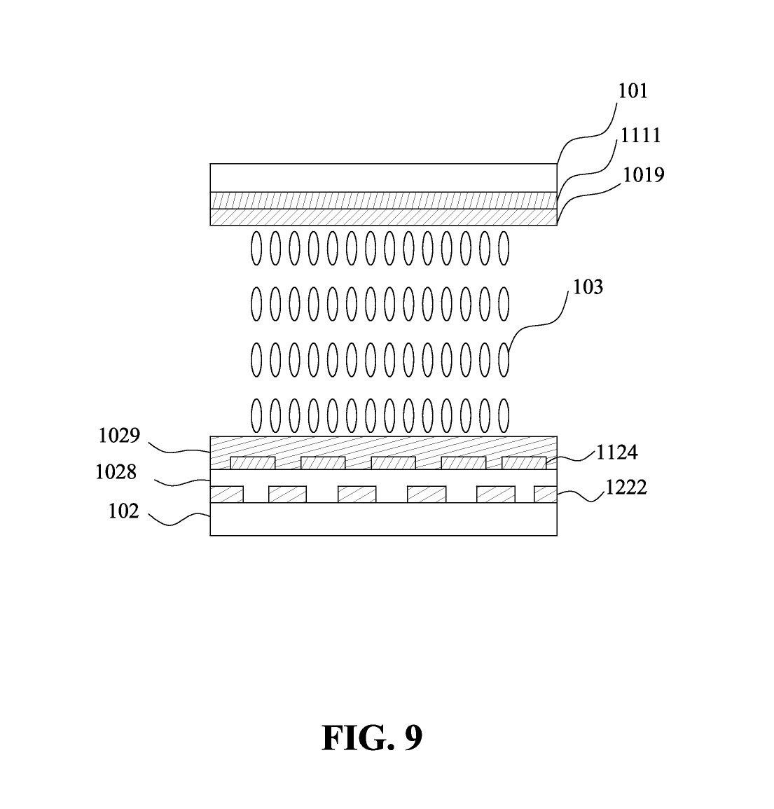

The cross sectional view of the LCD device in this embodiment similar to that in the first embodiment shown in FIG. 3 is shown in FIG. 9. As can be seen from the cross sectional view, both the second electrode 1222 and the fourth electrode 1124 are patterned electrodes. However, the second electrode 1122 shown in FIG. 3 is a non-patterned planar electrode.

In accordance with this embodiment, the first electrode 1111 is applied with a DC voltage Vcom. The second electrode 1222 is applied with an AC voltage VP which is synchronous with Vsync of the LCD device. The third electrode 1123 is applied with an AC voltage Vb1 and the fourth electrode 1124 is applied with an AC voltage Vb2. Both Vb1 and Vb2 are synchronous with Vsync.

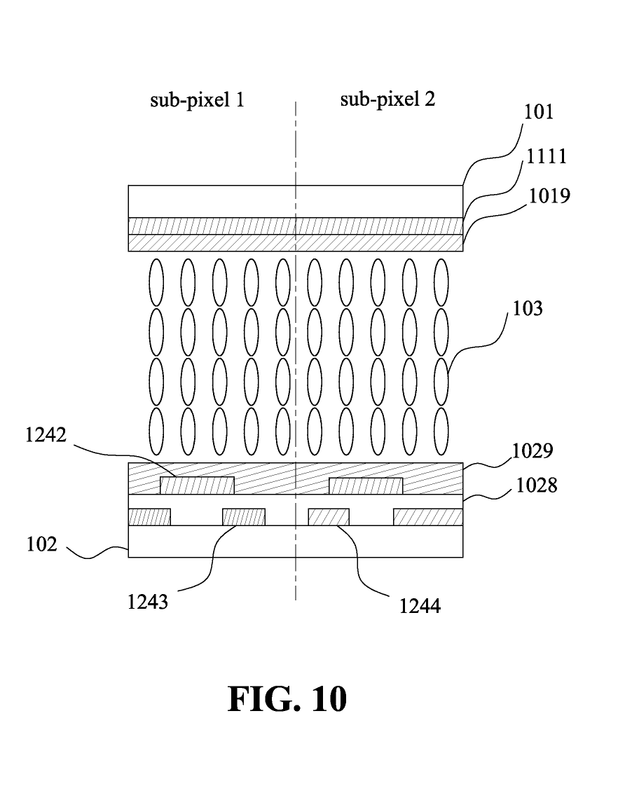

FIG. 10 shows the cross sectional view of an LCD device according to another variation of the first embodiment of the present invention. Similar to the LCD device shown in FIG. 8, in this variation the second, third and fourth electrodes are all patterned electrodes. It should be noted that in FIG. 8, the second electrode 1222 is a patterned electrode formed directly above the second substrate 102 in the whole pixel area, and the third and fourth electrodes 1123, 1124 are two separate patterned electrodes embedded in the second alignment layer 1029 respectively in the first and second sub-pixel areas. However, in FIG. 10, the second electrode 1242 is a patterned electrode embedded in the second alignment layer 1029 in the pixel area, and the third and fourth electrodes 1243, 1244 are two separate patterned electrodes formed directly above the second substrate 102 respectively in the first and second sub-pixel areas.

As can be seen from FIG. 10, the first electrode 1111 is applied with a DC voltage Vcom. The second electrode 1242 is applied with an AC voltage VP synchronous with Vsync of the LCD device. The third electrode 1243 is applied with an AC voltage Vb1 and the fourth electrode 1244 is applied with an AC voltage Vb2. Both Vb1 and Vb2 are synchronous with Vsync.

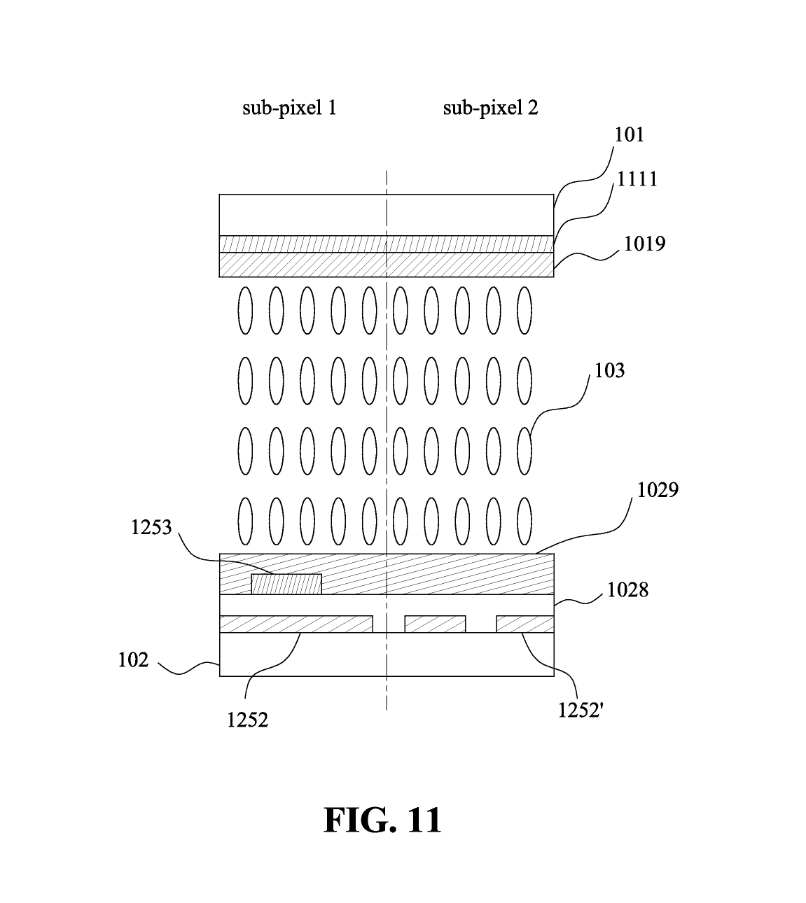

FIG. 11 shows the cross sectional view of an LCD device according to a further variation of the first embodiment of the present invention. In this variation, the electrodes in the two sub-pixel areas are formed differently. In the first sub-pixel area, the second electrode 1252 is a non-patterned planar electrode and the third electrode 1253 is a patterned electrode embedded in the second alignment layer 1029. In the second sub-pixel area, the second electrode 1252′ is a patterned electrode and there is no electrode embedded in the second alignment layer 1029.

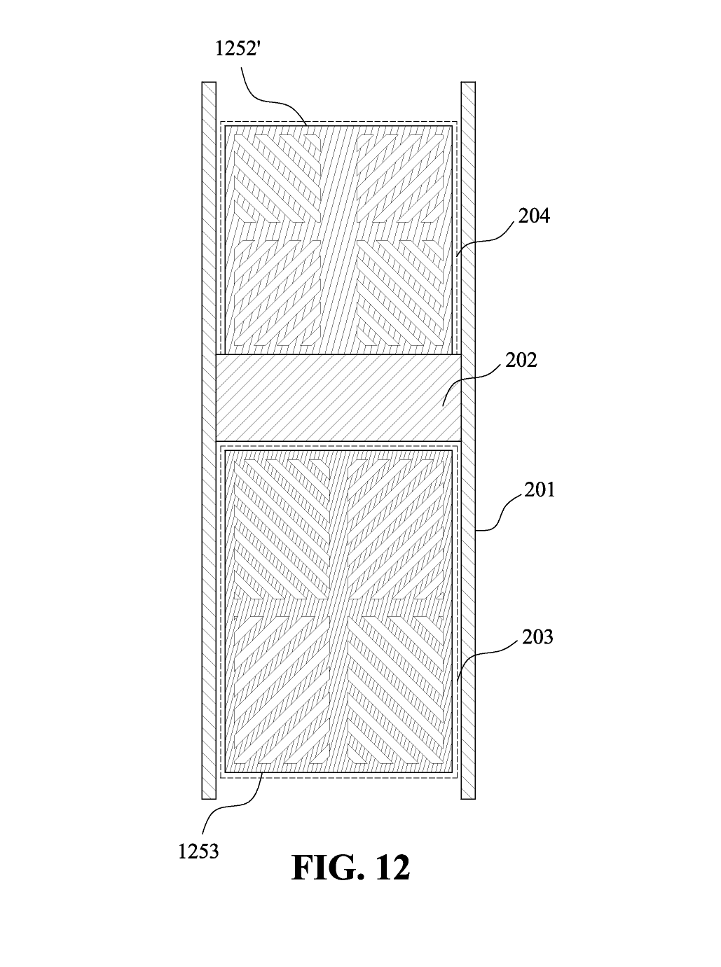

The top view of a pixel area defined by the data line 201 and the gate line in the LCD device of FIG. 11 for illustrating the second and third electrodes 1252′, 1253 is shown in FIG. 12. As can be seen, the first sub-pixel area 203 comprises a third electrode 1253 that is a patterned electrode embedded in the second alignment layer 1029, and the second sub-pixel area 204 comprises a second electrode 1252′ that is also a patterned electrode formed on the second substrate 102.

In this embodiment, the first electrode 1111 is applied with a DC voltage Vcom. The second electrode 1252 and 1252′ is applied with an AC voltage VP synchronous with Vsync of the LCD device. The third electrode 1253 is applied with an AC voltage Vb1 that is also synchronous with Vsync.

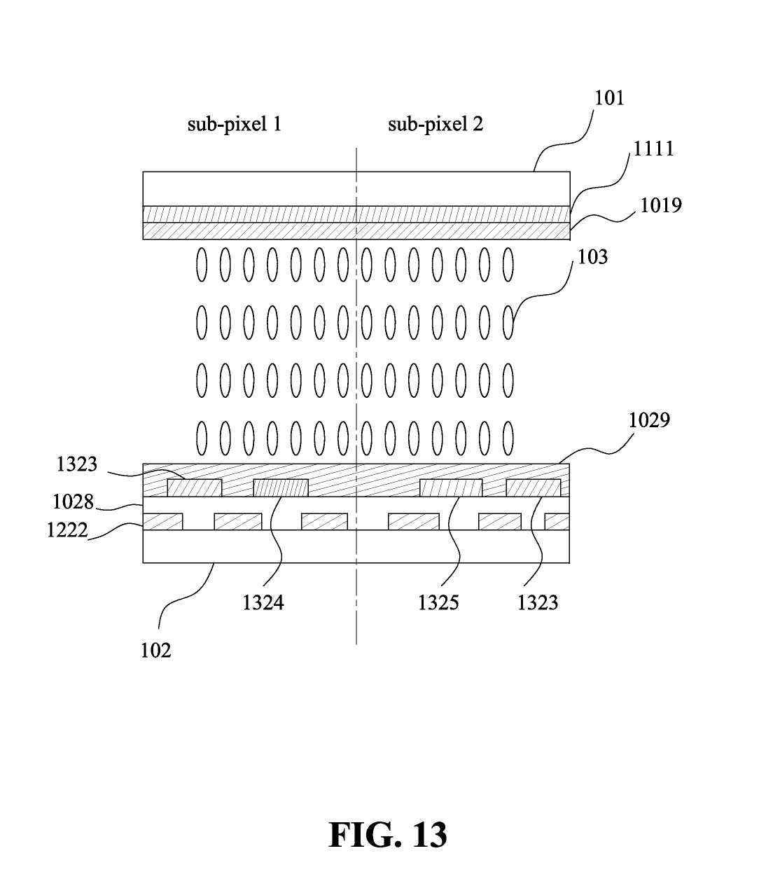

FIG. 13 shows a cross sectional view of an LCD device having at least three electrodes according to another variation of the first embodiment of the present invention. In comparison to the embodiment shown in FIG. 8, it can be seen that the LCD device of this embodiment is formed with first and second electrodes identical to those of FIG. 8. The first electrode 1111 is a non-patterned planar electrode and the second electrode 1222 is a patterned electrode.

In the embodiment of FIG. 13, there are third, fourth and fifth electrodes 1323, 1324 and 1325 that are patterned electrodes embedded in the second alignment layer 1029 on the passivation layer 1028. In the first sub-pixel area, the third electrode and fourth electrode 1323, 1324 are embedded in the second alignment layer 1029. In the second sub-pixel area, the third and fifth electrodes 1323, 1325 are embedded in the second alignment layer 1029.

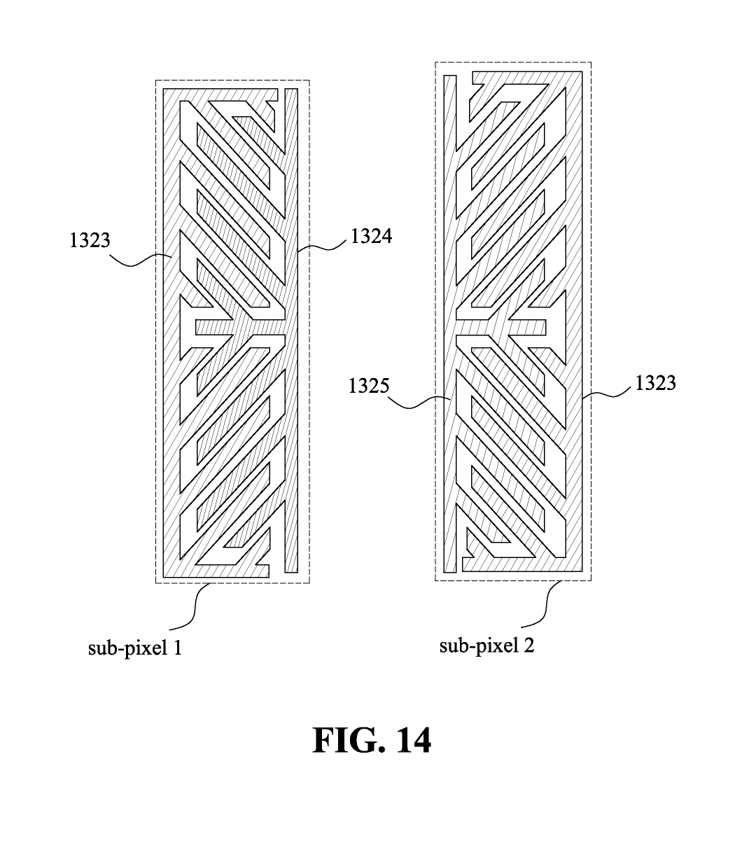

FIG. 14 shows the top view of the third, fourth and fifth electrodes 1323, 1324 and 1325 in the two sub-pixel areas in this embodiment. It is worth mentioning that the patterns of the third, fourth and fifth electrodes may be rotated with 90°, 180° or 270°. As can be seen in FIG. 14, the electrode pattern in the second sub-pixel area is identical to that of the first sub-pixel area rotated by 180°. However, the electrode patterns in the two sub-pixel areas may be identical or do not have to be identical and may also be rotated with different angles. According to the present invention, it is preferred that the branches and main trunks in the electrode pattern form an angle between 40 to 50 degrees.

In this embodiment, the first electrode 1111 is applied with a DC voltage Vcom. The second electrode 1222 is applied with an AC voltage VP1 synchronous with Vsync of the LCD device. The third, fourth and fifth electrodes 1323, 1324 and 1325 are applied with AC voltages VP3, VP4 and VP5 respectively. During the voltage rising period when the applied voltage across the liquid crystal layer changes from a low voltage to a high voltage, VP1=Vcom, VP3≠VP4≠VP5, and during the voltage falling period when the applied voltage across the liquid crystal layer changes from the high voltage to the low voltage, VP3=VP4=VP5 and VP1≠Vcom. Voltage VP1 is identical to VP shown in FIG. 4, and voltages VP3, VP4 and VP5 may have high-level and low-level periods similar to Vb1 or VP shown in FIG. 4 with identical or different magnitudes.

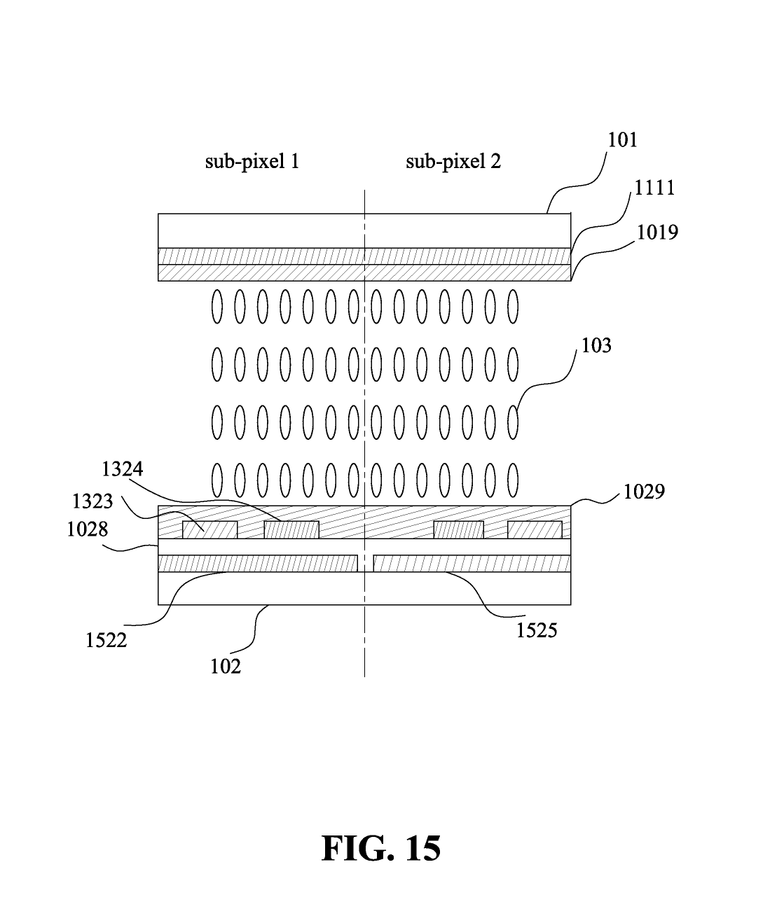

FIG. 15 shows a cross sectional view of an LCD device having at least three electrodes according to yet another variation of the first embodiment of the present invention. In this embodiment, the first electrode 1111 formed on the first substrate 101 is still a non-patterned planar electrode. Two separate non-patterned planar electrodes 1522, 1525 are respectively formed in the two sub-pixel areas on the second substrate. In each sub-pixel area, the third and fourth electrodes 1323, 1324 are patterned electrodes embedded in the second alignment layer 1029.

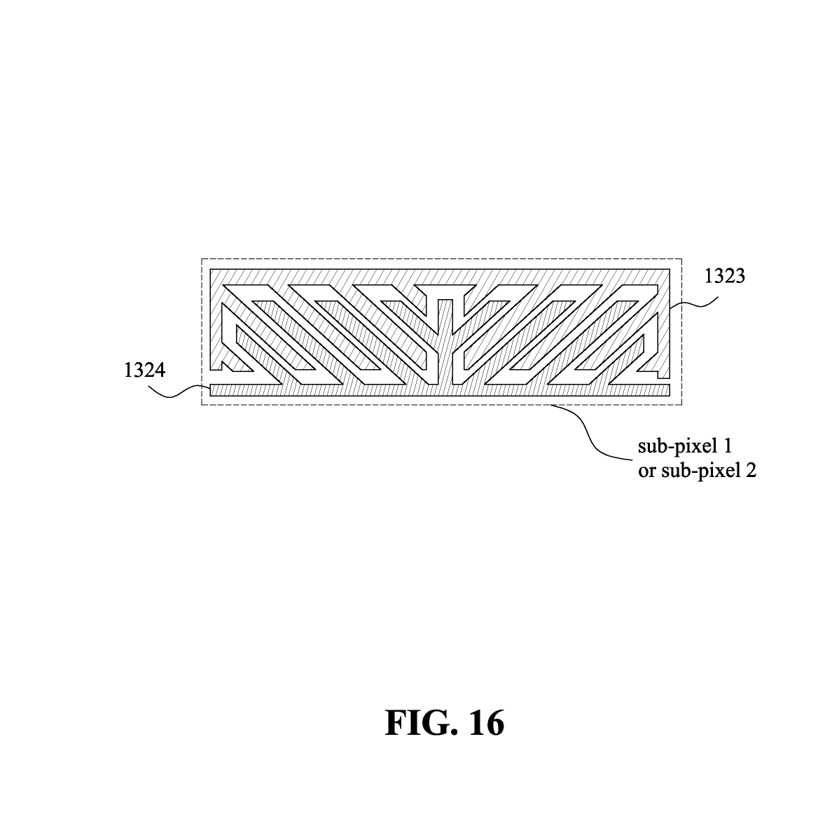

FIG. 16 shows the top view of the third and fourth electrodes 1323, 1324 in each sub-pixel area. As mentioned before, the patterns of the third and fourth electrodes may be rotated with 90°, 180° or 270° according to the present invention. The electrode patterns in the two sub-pixel areas may also be rotated with different or identical angles. Preferably, the branches and main trunks in the electrode pattern form an angle between 40 to 50 degrees.

As can be seen from FIG. 15, the two electrodes 1522 and 1525 are applied with VP1 and V5 respectively. The first electrode 1111 is applied with a DC voltage Vcom. The third and fourth electrodes 1323 and 1324 are applied with AC voltages VP3 and VP4 respectively. During the voltage rising period, VP1=Vcom, V5 may be a DC voltage different from Vcom, and VP3 and VP4 have same high-level and low-level periods that may be identical to those of VP or Vb1 shown in FIG. 4 but with different magnitudes. During the voltage falling period, VP3=VP4, VP3 and VP4 have same high-level and low-level periods that may be identical to those of VP or Vb1 shown in FIG. 4, VP1≠Vcom and VP5≠Vcom. VP1 and VP5 have same high-level and low-level periods that may be identical to those of VP or Vb1 shown in FIG. 4 but with different magnitudes. VP1 and VP3 have different high-level and low-level periods.

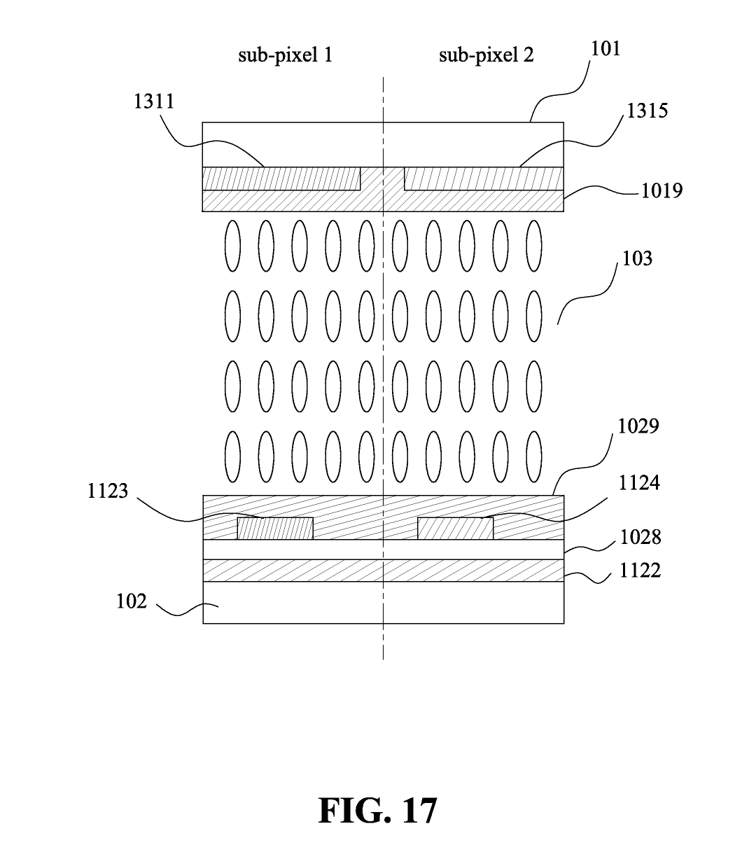

In the first embodiment and its variations as described above, the first electrode 1111 of the LCD device is a non-patterned planar electrode formed on the first substrate 101 covering the whole pixel area. In accordance with the second embodiment of the present invention, two separate non-patterned planar electrodes are respectively formed on the first substrate 101 for the two sub-pixel areas. FIG. 17 shows a cross sectional view of an LCD device having at least three electrodes according to the second embodiment of the present invention.

In the second embodiment shown in FIG. 17, the LCD structure is almost identical to that of FIG. 1 except that the non-patterned first electrode 1111 formed on the first substrate 101 in FIG. 1 is replaced by two separate non-patterned planar electrodes 1311 and 1315 respectively in the first and second sub-pixel areas.

As can be seen from FIG. 17, the two electrodes 1311 and 1315 are applied with Vcom and V5 respectively. The second electrode 1122 is applied with an AC voltage VP. The third and fourth electrodes are applied with AC voltage Vb1 and Vb2 respectively. V5 is a DC voltage equal to or different from Vcom. V5 may also be an AC voltage identical to Vb1 or Vb2.

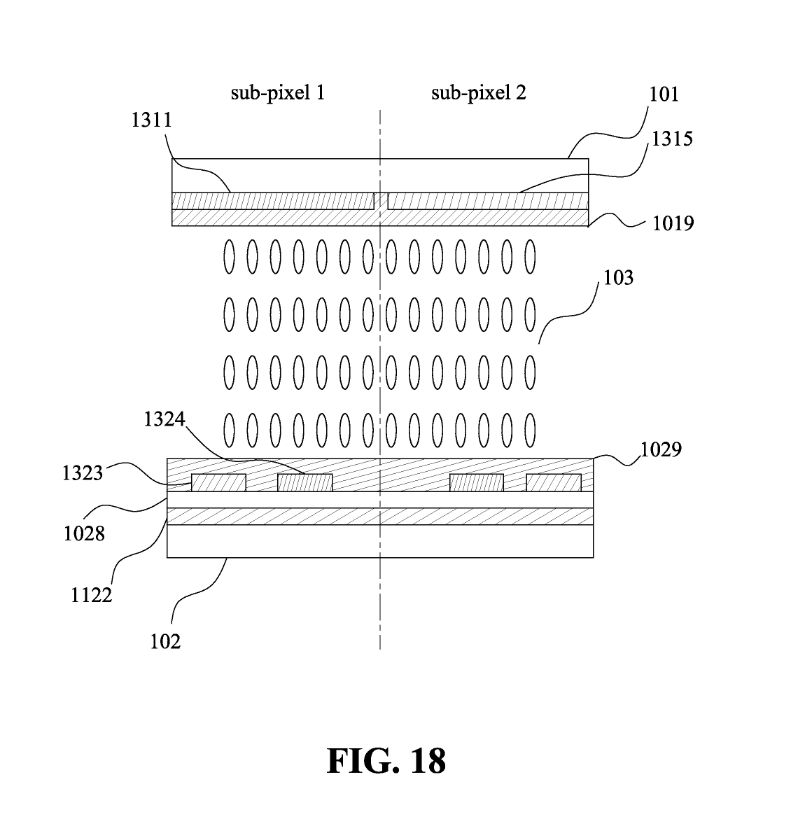

FIG. 18 shows a cross sectional view of an LCD device having at least three electrodes according to a variation of the second embodiment of the present invention. As can be seen from FIG. 18, the LCD structure is very similar to that shown in FIG. 17 except that in each sub-pixel area of this embodiment, the third and fourth electrodes 1323, 1324 are patterned electrodes embedded in the second alignment layer 1029. In other words, each sub-pixel area has two patterned electrodes instead of one patterned electrode.

In comparison to the embodiment shown in FIG. 15, the two LCD structures in FIGS. 15 and 18 are also very similar except that the non-patterned planar electrodes formed on the first and second substrates in FIG. 15 are formed respectively on the second and first substrates in FIG. 18 instead.

As can be seen from FIG. 18, the two electrodes 1311 and 1315 are applied with VP1 and V5 respectively. The second electrode 1122 is applied with a DC voltage Vcom. The third and fourth electrodes 1323 and 1324 are applied with AC voltages VP3 and VP4 respectively. During the voltage rising period, VP1=Vcom, V5 may be a DC voltage different from Vcom, and VP3 and VP4 have same high-level and low-level periods that may be identical to those of VP or Vb1 shown in FIG. 4 but with different magnitudes. During the voltage falling period, VP3=VP4, VP3 and VP4 have high-level and low-level periods that may be identical to those of VP or Vb1 shown in FIG. 4, VP1≠Vcom and VP5≠Vcom. VP1 and VP5 have same high-level and low-level periods that may be identical to those of VP or Vb1 shown in FIG. 4 but with different magnitudes. VP1 and VP3 have different high-level and low-level periods.

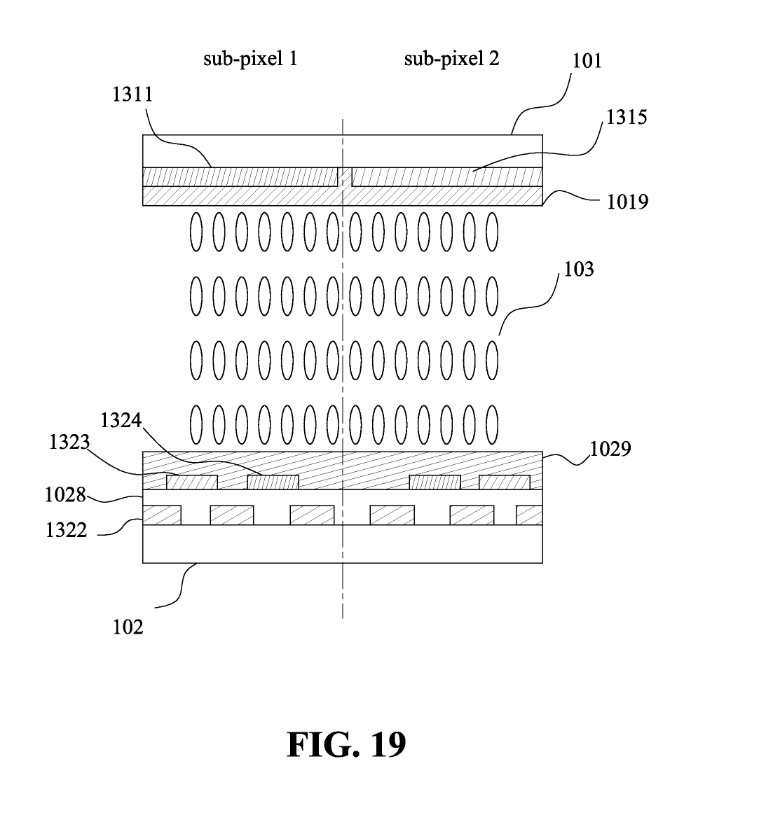

FIG. 19 shows a cross sectional view of an LCD device having at least three electrodes according to another variation of the second embodiment of the present invention. As can be seen, this embodiment is almost identical to the embodiment shown in FIG. 18 except that the non-patterned planar second electrode 1122 formed on the second substrate is replaced with a patterned electrode 1322. The voltages applied to various electrodes in this embodiment are also identical to those described for the LCD device shown in FIG. 18.

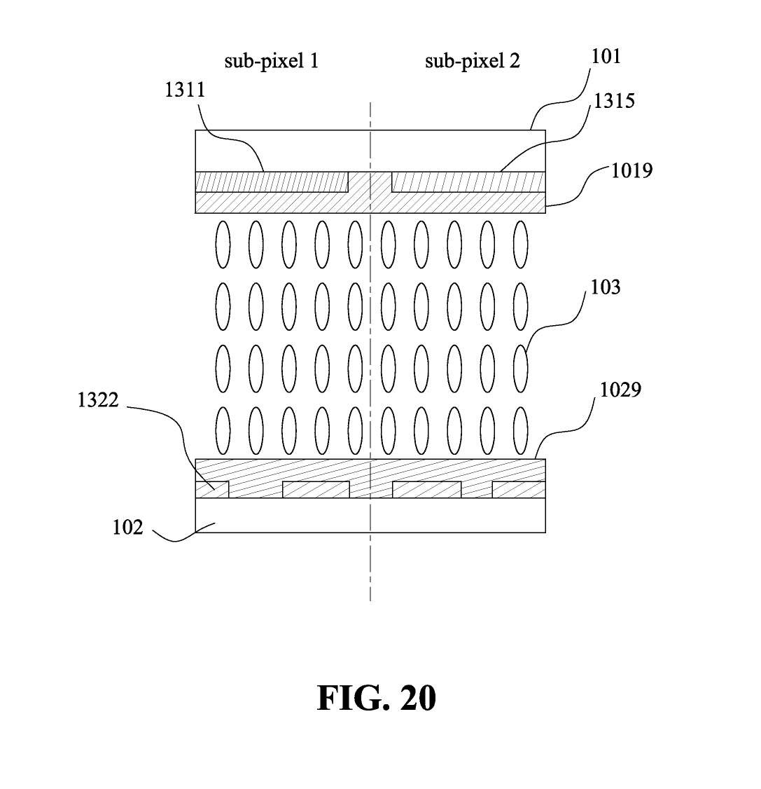

FIG. 20 shows a cross sectional view of an LCD device having at least three electrodes according to a further variation of the second embodiment of the present invention. As can be seen, the electrodes 1311 and 1315 are two separate non-patterned planar electrodes formed on the first substrate 101 respectively in the two sub-pixel areas. The second electrode 1322 formed on the second substrate 102 is a patterned electrode covering the pixel area, and the second alignment layer 1029 is formed over the second electrode 1322.

According to FIG. 20, the two electrodes 1311 and 1315 are applied with VP and V3 respectively. V3 is an AC voltage identical to Vb1 shown in FIG. 4. The second electrode 1322 is applied with a DC voltage Vcom.

It should be noted that the first and second embodiments shown and described above are for purpose of illustrating the principle of the present invention. A person of ordinary skill in the art can realize that many other variations can further be derived from the embodiments that have been described. For example, the patterned electrode 1222 formed on the second substrate 102 in FIG. 13 may be replaced by a non-patterned planar electrode, and the non-patterned planar electrode 1122 formed on the second substrate 102 in FIG. 17 may be replaced by a patterned electrode.

According to the present invention, at least three electrodes are disposed in each pixel area and applied with a DC voltage and two AC voltages. Both AC voltages are synchronous with the LCD timing signal and have a high-level period and a low-level period equal to the high-level period. The timing period of the LCD timing signal is at least one or more times of the high-level periods of the two AC voltages with the high-level period of one AC voltage longer than the high-level period of the other AC voltage. It should also be noted that the voltages applied to the electrodes in various embodiments described above are examples for illustration purpose only. The voltages applied to the electrodes are interchangeable and not limited to those examples.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A method for driving an LCD device having a plurality of pixel areas, each pixel area including at least two sub-pixel areas formed with at least first, second and third electrodes outside a non-transparent area, the LCD device having an LCD timing signal with a timing period, and the method comprising:
applying a DC voltage to the first electrode;
applying a first AC voltage to the second electrode, the first AC voltage being synchronous with the LCD timing signal and having a first high-level period and a first low-level period equal to the first high-level period, the timing period being equal to N times of the first high-level period with N being an integer no less than 1, the first AC voltage being greater than the DC voltage in the first high-level period and less than the DC voltage in the first low-level period; and
applying a second AC voltage to the third electrode, the second AC voltage being synchronous with the LCD timing signal and having a second high-level period and a second low-level period equal to the second high-level period, the timing period being equal to M times of the second high-level period with M being an integer no less than 2, the second AC voltage being greater than the DC voltage in the second high-level period and less than the DC voltage in the second low-level period;
wherein M is greater than N.

2. The method as claimed in claim 1, wherein the LCD timing signal is a vertical synchronous signal of the LCD device.

3. The method as claimed in claim 1, wherein during the first high-level period of the first AC voltage, the second AC voltage changes from the second high-level period to the second low-level period, and during the first low-level period of the first AC voltage, the second AC voltage also changes from the second high-level period to the second low-level period.

4. The method as claimed in claim 1, wherein during the first high-level period of the first AC voltage, the second AC voltage changes from the second high-level period to a middle-level period, and during the first low-level period of the first AC voltage, the second AC voltage changes from the second low-level period to a middle-level period, the middle-level period and the second high-level period having identical duration.

5. The method as claimed in claim 1, wherein M is an integer multiple of N.

6. The method as claimed in claim 1, wherein each cycle of the first AC voltage is formed by one first high-level period and one first low-level period, and each cycle of the second AC voltage is formed by one second high-level period followed by one middle-level period followed by one second low-level period followed by one middle-level period, the middle-level period and the second high-level period having identical duration.

7. The method as claimed in claim 1, wherein each cycle of the first AC voltage is formed by one first high-level period and one first low-level period, and each cycle of the second AC voltage is formed by one second high-level period followed by one middle-level period followed by one second high-level period followed by one middle-level period followed one second low-level period followed by one middle-level period followed one second low-level period followed by one middle-level period, the middle-level period and the second high-level period having identical duration.

8. An LCD device having a plurality of pixel areas and an LCD timing signal with a timing period, each pixel area including at least two sub-pixel areas outside a non-transparent area and further comprising:
a first substrate, a second substrate and a liquid crystal layer disposed between the first and second substrates;
at least first, second and third electrodes disposed between the liquid crystal layer and the two substrates with at least one of the electrodes disposed between the first substrate and the liquid crystal layer, and at least one of the electrodes disposed between the second substrate and the liquid crystal layer;
the first electrode being applied with a DC voltage;
the second electrode being applied with a first AC voltage, the first AC voltage being synchronous with the LCD timing signal and having a first high-level period and a first low-level period equal to the first high-level period, the timing period being equal to N times of the first high-level period with N being an integer no less than 1; and
the third electrode applied with a second AC voltage, the second AC voltage being synchronous with the LCD timing signal and having a second high-level period and a second low-level period equal to the second high-level period, the timing period being equal to M times of the second high-level period with M being an integer no less than 2;
wherein M is greater than N.

9. The LCD device as claimed in claim 8, wherein the first electrode is a non-patterned planar electrode.

10. The LCD device as claimed in claim 8, wherein the first electrode is a patterned electrode.

11. The LCD device as claimed in claim 8, wherein the second electrode is a non-patterned planar electrode.

12. The LCD device as claimed in claim 8, wherein the second electrode is a patterned electrode.

13. The LCD device as claimed in claim 8, wherein the third electrode is a non-patterned planar electrode and the second electrode and the third electrode are disposed respectively in the two sub-pixel areas.

14. The LCD device as claimed in claim 8, wherein at least one of the electrodes in one of the two sub-pixel areas is applied with one of the DC and two AC voltages not applied to the electrodes in the other of the two sub-pixel areas.

15. The LCD device as claimed in claim 8, wherein the third electrode is a patterned electrode.

16. The LCD device as claimed in claim 15, wherein each pixel area further includes a fourth electrode, and the third and fourth electrodes are respectively disposed in the two sub-pixel areas, the fourth electrode being a patterned electrode applied with a third AC voltage, the third AC voltage being synchronous with the LCD timing signal and having a high-level period equal to the second high-level period, a low-level period equal to the second low-level period and a magnitude different from the magnitude of the second AC voltage.

17. The LCD device as claimed in claim 15, wherein the third electrode is disposed only in one of the two sub-pixel areas.

18. The LCD device as claimed in claim 16, wherein each pixel area further includes a fifth electrode and the second and fifth electrodes are respectively disposed in the two sub-pixel areas, the fifth electrode being a non-patterned planar electrode.

19. The LCD device as claimed in claim 18, wherein the fifth electrode is applied with a DC voltage having a magnitude different from the magnitude of the DC voltage applied to the first electrode.

20. The LCD device as claimed in claim 18, wherein the fifth electrode is applied with the second AC voltage.

21. The LCD device as claimed in claim 15, wherein each of the two sub-pixel areas includes at least two patterned electrodes applied with two different AC voltages.

22. The LCD device as claimed in claim 21, wherein one of the at least two patterned electrodes in one sub-pixel area is applied with an AC voltage different from the two AC voltages applied to the other sub-pixel area.
